(19) United States
(12) Patent Application Publication
(10) Pub. No.: US 2014/0324395 A1
(43) Pub. Date: Oct. 30, 2014

(54) Data Driven Placemaking

(71) Applicants: David Silverman, Boston, MA (US); Salil Patel, Houston, TX (US); Anthony Frausto-Robledo, Marblehead, MA (US)

(72) Inventors: David Silverman, Boston, MA (US); Salil Patel, Houston, TX (US); Anthony Frausto-Robledo, Marblehead, MA (US)

(21) Appl. No.: 13/889,427

(22) Filed: May 8, 2013

Related U.S. Application Data
(60) Provisional application No. 61/644,062, filed on May 8, 2012.

(51) Int. Cl. G06F 17/50; G06N 5/04

(52) U.S. Cl. CPC G06F 17/50; G06N 5/04
USPC 703/1

(57) ABSTRACT

The embodiments described herein relate to a modeling system that defines index categories and uses model variables for analyzing successful or non-successful implementation. Data Driven Placemaking (DDP) provides evidence-based support to stakeholders (including designers, decision makers, policy makers, academics, and community members) for the purposes of improving designs for cities (and groupings of city regions and subsets of urban regions), via the collection, storage, transformation, analysis, and visualization of data relating to index categories and model variables.

This application claims the benefit of U.S. Provisional Patent Application No. 61/644,062 filed May 8, 2012.

### FIELD OF THE INVENTION

The present invention relates to the field of placemaking, and in particular it relates to modeling that defines index categories and uses model variables for analysis of successful or non-successful implementation. Output variables are to assist in planning and generating a score card for a proposed design model, as well as predicting design model success.

### BACKGROUND OF THE INVENTION

New cities are being created, and existing cities are growing, faster than ever before. For the first time in human history, over half of the global population lives in cities, and the percentage of individuals living in urban spaces is expected to reach 55% by 2030.

In the industrialized world, people migrate to cities as they seek opportunities for employment, education, and cultural enrichment. Cities are often viewed as concentrations of wealth, industry, and human capital.

In the United States, in particular, demographic factors (including aging cohorts and continued immigration), and cost-related drivers (such as rising or volatile prices for energy, housing, and transportation) are increasing aggregate demand for denser, more flexible, and sustainable living environments. Such environments may include any number of commercial, industrial, educational, cultural, housing, and mixed-use facilities. Relating to housing trends alone, an estimated 57 million new and replacement urban units will be required by 2030 (United States National Research Council, Transportation Research Board. “Driving and the Built Environment: The Effects of Compact Development on Motorized Travel, Energy Use, and CO2 Emission,” December 2011). Furthermore, the data suggests that, from 2000 to 2050, the total number of housing units in the US is expected to double, to nearly 200 million units.

To meet these pressing needs, modern urban planners and policymakers must deliver and evaluate new plans quickly and effectively. Yet, stakeholders (including architects, designers, developers, governments, local communities, and other stakeholders) still lack appropriate tools for the efficient design, comparison, and assessment of spaces that are ultimately vibrant, safe, healthy, engaging, and productive—i.e., “successful.” Such successful spaces can serve as engines for economic growth and humanistic endeavor.

Conversely, poorly-planned and improperly-implemented “placemaking” may impose immediate and long-run costs to stakeholders, and to society at large; as spaces become underused, blighted, and depopulated. As such, “failed” urban regions can become vacuums for commerce, nexuses for criminality, and foci of environmental deterioration.

Often, externalities and problems created by poor urban planning decisions grow more intractable, and more expensive to address, with the passage of time. The resulting explicit and embedded costs to business owners, property owners, taxpayers, and municipal governments are significant.

Over the past half-century, as ideas about placemaking have undergone successive revolutions, planners with good intentions have nevertheless created “failed” places. This disappointing result in large measure attributable to an unmet need for evidence-based, data-driven methodologies relating theory to practice, and ideation to experience. Such a need arises because the factors that should be considered when designing a new urban neighborhood, or redeveloping an existing one, are often so numerous that it is impossible to expect designers and decisionmakers to take every relevant factor into account. Many such factors are thus left unattended or necessarily ignored given time constraints and other attentional limitations.

It should be noted, that many implemented plans are never seen by their designers due to the long amount of time and a myriad of factors that impact master plans. Furthermore, there remain widespread disagreements about what can and should be done to create successful urban spaces.

Thus, to avoid mistakes in prior development and redevelopment projects, to ensure continued innovation for future development, and to allow effective comparisons of competing approaches, stakeholders deserve more appropriate tools to manipulate and transform both subjective and objective information, as measures relating to time, people, properties, and places.

### SUMMARY OF THE INVENTION

The embodiments described herein relate to a modeling system that defines index categories and uses model variables for analyzing successful or non-successful implementation. Data Driven Placemaking (DDP) assists the designer and decision maker by using model variables for evidence-based support for positive urban design. As used, the term urban design necessarily incorporates design activities relating to groupings of city regions and as well as subsets of urban regions.

In brief, DDP enables model-driven, contextual evidence to support better design and empower better planning decisions.

The advent of hardware and software technologies for data handling (including assimilation, curation, storage, analysis, modeling, and display) has enabled inventive approaches to transforming information (whether structured or unstructured) into contextually-relevant, value-creating knowledge. The embodiments described herein relate to a software modeling system that makes use of extensive new approaches to data handling and transformed information.

DDP is a sophisticated tool aiding in the process of placemaking, to be used by city planners, policy-makers, designers, property owners, developers, and community members-at-large. DDP compliments the intelligence and experience such stakeholders by serving as a design and analysis guide.

Using DDP, the designer and decision maker can take every single factor at work in the problem of placemaking into account. DDP can synthesize a multitude of data related to the problems of placemaking as well as contextual information based on site. DDP model variables allow for every factor of what makes a successful urban space as a measurable data point, and in so doing encourages a holistic approach to planning.

In the present era, the development process typically unfolds with a designer and/or decisionmaker laying out the goals and ambitions for the project. Research is conducted based on the site, and designers may look to precedents to inspire their work. Finally, a completed design is evaluated based on whether it achieves the aforementioned goals.

Currently, despite the proliferation of theory and working knowledge in this domain, the evidence-based analysis (and practical implementation) of “successful” or “failed” city regions—from economic, environmental, quality-of-life, and other perspectives—remains an impractical, incomplete, and inefficient process.

DDP crosses that chasm, bridging the divide between information and knowledge—by enabling aggregation, validation, curation, transformation, and visualization of variables, each in context—as the volume of structured and unstructured data informing “better” design ever increases.

DDP makes such context-relevant knowledge accessible, in practical and participatory formats, to planners, policymakers, and the public at large.

Advantageously, DDP uses model variables for the design process that are often left uncaptured or ignored: variables that relate to the culture of place. One advantage of the present system is that it, in several embodiments, it is able to process vast volumes of demographic information (i.e, the “human factor” of successful cities). Model variables may include information such as: the movement of people in and through a place, the kinds of people that live and work or want to live and work in a place, and the activities that occur in these places—eg, what people do on a holiday or on their lunch break. DDP is capable of collecting this data, and creating new data via algorithmic processing, modeling, and information visualization, thus bringing both systematic and holistic understandings of the “cultural” implications of a project.

### BRIEF DESCRIPTION OF THE DRAWINGS

The invention will be now shown with the following description of an exemplary embodiment thereof, exemplifying but not limitative, with reference to the attached drawings in which:

FIG. 1 illustrates a DDP index category for Access and Linkages 100 in which the model variables of the present invention may be employed including a data-driven framework that depends on input data;

FIG. 2 illustrates an example index category framework that represents Uses and Activities 101 and the associated model variables;

FIG. 3 illustrates an embodiment of the index category of Sociability 102, with subcategories for model variables;

FIG. 4 illustrates an embodiment of the index category of Comfort & Image 103, with sub categories for model variables;

FIG. 5 illustrates an embodiment of the index category of Sustainable 104, with sub categories for model variables;

FIG. 6 schematically illustrates the flow chart pipeline for the analytics portions of the present invention 105;

FIG. 6A further illustrates the flow chart pipeline for the analytics portions of the present invention 106;

FIG. 7 shows an example of data sourcing for DDP analytics of successful and non-successful design 107.

FIG. 8 illustrates example model ResilienCity with canal connecting nature to people within the district 108;

FIG. 9 shows example model ResilienCity with ramblas 109;

FIG. 10 shows an overhead perspective of example model ResilienCity 110;

FIG. 11 shows a model's output index category scorecard in Comfort and Image on resulting analysis of model output variables 111;

FIG. 12 shows a model's output index category scorecard in Uses and Activities with implementation of model output variables 112;

FIG. 13 shows a model's output index category scorecard in Access and Linkages on resulting analysis of model output variables 113;

FIG. 14 shows model's output index category scorecard in Sociability on resulting analysis of model output variables 114;

FIG. 15 shows model's output index category scorecard in Sustainable on resulting analysis of model output variables 115;

### DETAILED DESCRIPTION

In view of the foregoing background, the present disclosure presents a modeling system, and related methods which advantageously organizes the data it collects into index categories. Advantageously, in one embodiment of the invention, five index categories are used: Comfort & Image, Sustainability, Sociability, Access & Linkages, and Uses & Activities. Each category is broken down into as many measurable points as possible in order to provide information about the quality of the place in question.

Techniques and technologies in natural language processing, information storage and retrieval, knowledge representation, decision support, machine learning, and graphical information visualization working with open domain question answering are particularly suited for working with DDP in the preferred embodiment. These technologies allow DDP to provide design recommendations, especially in providing and suggesting comparison regions, cities, and neighborhoods for design models, creating new “hybrid” comparators, and in objectively evaluating proposed design models.

Significant natural language programs have become possible with advances in computational power and the implementation of machine learning algorithms for language processing. Large databases of typical real world examples allow a machine learning algorithm to generate models that are used for analyzing new data. Several such “Big Data” technologies are presently incorporated, for instance, in IBM's “Watson” and “DeepQA” computer and software systems.

In one embodiment of DDP, the user invokes the DDP system to initiate visualization of the data sources as data or metadata (i.e. data relating to data) over 2D and 3D project location models. A data (or metadata), overlay binds itself to location points, 2D fields or 3D volumetric regions, or all of the above, within the proposed design, by variously scaled means from manual user interface actions with DDP system or by automatic commands run from within the DDP system.

Upon completion of this binding process, DDP generates subsequent data results based on any number of modular, user-defined modules or algorithms or other processing toolkits defined within the system. These algorithms preferably have opportunity for statistical weighting allowing for urban designer and project collaborators to set project priorities by assigning weight to each of the categories.

One such envisioned processing component/module may be IBM's Watson, as mentioned previously; others may include REFS (from Via Sciences), or any number of software and/or hardware based toolkits for query, modeling, prediction, statistical, inferential, or analysis of data and information.

In another embodiment of the invention described herein, DDP is capable of capturing multiple data types, including but not limited to, capturing natural language, queries, images, publically available documents, spreadsheets, data records, and data originating from community-based platforms such as social media, whether directly, or through processing and analysis. Community-sourced data and community evaluated data may be considered a representation of the “community's voice.” Each data element may be associated with a number of metadata properties or resources, which may: tag the data as relating to one or more source, such as geographic elevation or GPs coordinates, identify the origin and log the use-history of the data element, mark data with dates and times such as stamps for entry or processing, or add other indicator flags such as watermarks, signals of third-party validation, or verification. All such data (and/or metadata) may be stored, tagged, validated, curated, aggregated, and transformed by the system. In one such transformation, data, or associated meta-data, may be applied in graphical representation as one or more visual overlays. Tools such as natural language query and summation, may drive new analytic models or filtering regimes.

In the most preferred embodiment of DDP, the user interacts with the system via a graphical representation of the project locale. This locale is mapped in multiple-dimension, 2D, 3D, 4D, nD data in a manner that enables interoperability via traditional data exchange frameworks, including but not limited to: IFC, XML, gbXML. The user can manually associate and assign index categories and sub-categories to specific icons user-located or auto-located on the model representation of the project design context. This process is a stage in the DDP software workflow that both precedes and follows the binding of data or metadata, as part of the iterative designer's workflow with the DDP system.

In one embodiment, DDP allows capture of not only the ex-ante, formalized regulatory/architectural requirements for a particular site or neighborhood, but also the ex-post characteristics. Ex-post characteristics include the particular formula, at a moment in time of a particular neighborhood or even a city, thus creating a unique signature for describing the particular site. The unique signature is the facilitation of appropriate precedent sites for urban planning. Not only is it contemplated by the present invention that the signature concept enables identification of myriad potential comparators from around the world, filtered by overlays of myriad data-types, but it is further contemplated that entirely new, “hybrid,” synthetic sites may be constructed. In one embodiment, a designer uses precedents as a part of the design strategy; for example: while creating or evaluating on a design for college campus in a given city, a DDP user may construct a synthetic comparator derived from data in selected regions in a selection cities. For example, a user may create a hybrid of large university campuses from Providence, Boston, New York and San Francisco; weighted as 60% Providence, 20% Boston, 10% New York, and 10% San Francisco. A complementary scenario envisions a user focusing on a single location, observing over time how selected scores and metrics co-located to site location change: visually connecting in causal and/or inferential relation to one another as time elapses and a neighborhood, city, or region matures.

In a further embodiment, in addition to than a binary pass or fail score, the modularity of the DDP system provides raw or scaled benchmark whereby any of a variety of algorithms or computational models are applied to establish relative criteria. For example relative criteria can be defined as Optimal, Good, and Baseline criteria in the DDP indices, at the index or sub-index level. Algorithmic methods used for data transformation may vary, at user selection, and depending on the hardware and software available at point of access (such as with a local supercomputer installation) as enabled by a modular and/or API-based, and/or distributed software architecture. Application of any number of standards to data elements within the indices are contemplated (in analogy to the LEED rating system as used for “green” buildings). By providing a multi-level benchmark for a passing score across the system per index, DDP can establish unique signatures. As studies of design precedents take place using the DDP system, users may find that differing cases vary by some measures, yet still result in successful urban and suburban developments, by other measures.

In one embodiment, unique signatures per index are created by the user based on the overall goal level the project using agents. Project wide benchmarks may be described as Optimal, Good, or Baseline. Precedent data on localities already in the DDP system may be applied based on the benchmarks, or the user is able to select a benchmark level of Optimal, Good, or Baseline for each agent. Each agent has a pre-established applicable algorithms. The user selects the agent which corresponds to the applicable data, such as social media stream based data, public databases, private database, or input of values or set of values. Long term success can be measured for each DDP-based project with continued fine tuning of the methods and means of algorithm-based assessment. This in turn produces and refines given DDP based signatures. The signatures are then available to be charted, graphed, and further explored.

In a further embodiment, DDP provides multiple-level benchmarking with the capabilities to account more accurately for the varied differences in various successful formulas to urban planning as they have been realized in various domiciles and locales around the world.

It is contemplated that the novel functionality of the DDP may be applied not only in the design phase, but also for decision support in project management, financial projection, and risk management, via Reference Class Forecasting (RCF). DDP improves the utility and application of RCF. Large property, infrastructure, and building projects are often subject to agency-related and behavioral biases, which effective RCF may address. Specifically, DDP may provide readily-accessible comparators, and a greater variety of comparator ranges ranges, than conventional methods of RCF. RCF is introduced and further described by and hereby incorporated by reference: Kahneman D and Tversky A, “Prospect theory: An analysis of decisions under risk” in Econometrica, 47, 313-327 (1979); and Merrow E and Yarossi M, “Assessing Project Cost and Schedule Risk”, AACE Transactions, H.6.1 (1990).

For use with DDP, Information retrieval (IR) implementation includes searching for documents, metadata, databases and the World Wide Web. An IR implementation starts with a user entering a search into the system. Advantageously, IR systems typically return a score or numerical value with the result, expressing the confidence that the object returned in response to a query is relevant. Many algorithms have been used to express the success of an IR system.

The following are examples of such, and are meant to be illustrative and not limiting to particular embodiments of the invention, and are collectively referenced from the following: Zhu M, “Recall, Precision and Average Precision”, Department of Statistics & Actuarial Science, University of Waterloo (Aug. 26, 2004); and Everingham, M; Van Gool, L; Williams, Christopher K; Winn, J; Zisserman, A, “The PASCAL Visual Object Classes (VOC) Challenge” International Journal of Computer Vision 88 (2): 303-338, (2010); and Brodersen K, Ong S, Stephan K, Buhmann J, “The binormal assumption on precision-recall curves”, Proceedings of the 20th International Conference on Pattern Recognition, 4263-4266, 2010; and Wikipedia, Information Retrieval http://en.wikipedia.org/wiki/Information_Retrieval (describing how Information Retrieval algorithms have developed; as accessed Apr. 12, 2012 11:50 EST).
Precision is the fraction of the documents retrieved that are relevant to the user's information need.

$$precision = \frac{\vert \{ relevant documents \} ⋂ \{ retrieved documents \} \vert}{\vert \{ retrieved documents \} \vert}$$

Recall is the fraction of the documents that are relevant to the query that are successfully retrieved.

$$recall = \frac{\vert \{ relevant documents \} ⋂ \{ retrieved documents \} \vert}{\vert \{ relevant documents \} \vert}$$

The proportion of non-relevant documents that are retrieved, out of all non-relevant documents available:

$$fall \text{-} out = \frac{\vert \{ non \text{-} relevant documents \} ⋂ \{ retrieved documents \} \vert}{\vert \{ non \text{-} relevant documents \} \vert}$$

For Information Retrieval, the weighted harmonic mean of precision and recall, the traditional F-measure or balanced F-score is:

$$F = \frac{2 \cdot precision \cdot recall}{( precision + recall )} .$$

This is also known as the F₁ measure, because recall and precision are evenly weighted.
The general formula for non-negative real β is:

$${F}_{β} = \frac{( 1 + {β}^{2} ) \cdot ( precision \cdot recall )}{( {β}^{2} \cdot precision + recall )} .$$

Two other commonly used F measures are the F₂ measure, which weights recall twice as much as precision, and the F_{0.5} measure, which weights precision twice as much as recall.
The F-measure was derived by van Rijsbergen (1979) so that F_{β} “measures the effectiveness of retrieval with respect to a user who attaches β times as much importance to recall as precision”. It is based on van Rijsbergen's effectiveness measure

$$E = 1 - \frac{1}{\frac{α}{P} + \frac{1 - α}{R}} .$$

Their relationship is

$${F}_{β} = 1 - E where α = \frac{1}{1 + {β}^{2}} .$$

Precision and recall are single-value metrics based on the whole list of documents returned by the system. For systems that return a ranked sequence of documents, it is desirable to also consider the order in which the returned documents are presented. By computing a precision and recall at every position in the ranked sequence of documents, one can plot a precision-recall curve, plotting precision p(r) as a function of recall r. Average precision computes the average value of p(r) over the interval from r=0 to r=1:

AveP=∫₀¹p(r)dr.
This integral is in practice replaced with a finite sum over every position in the ranked sequence of documents:

$$AveP = {\sum }_{k = 1}^{n} P ( k ) Δ r ( k )$$

where k is the rank in the sequence of retrieved documents, n is the number of retrieved documents, P(k) is the precision at cut-off k in the list, and Δr(k) is the change in recall from items k−1 to k.
This finite sum is equivalent to:

$$AveP = \frac{{\sum }_{k = 1}^{n} ( P ( k ) \times rel ( k ) )}{number of retrieved relevant documents}$$

Where rel(k) is an indicator function equaling 1 if the item at rank k is a relevant document, zero otherwise.
Where to interpolate the p(r) function to reduce the impact of “wiggles” in the curve. For example, the PASCAL Visual Object Classes challenge (a benchmark for computer vision object detection) computes average precision by averaging the precision over a set of evenly spaced recall levels {0, 0.1, 0.2, . . . 1.0}:

$$AveP = \frac{1}{11} {\sum }_{r ∈ \{ 0 , 0 , 1 , … , 1 , 0 \}} {p}_{interp} ( r )$$

Where pᵢₙₜₑᵣₚ(r) is an interpolated precision that takes the maximum precision over all recalls greater than r:

pᵢₙₜₑᵣₚ(r)=max _{r̅: r̅≧r}p(\tilde{r}).
An alternative is to derive an analytical p(r) function by assuming a particular parametric distribution for the underlying decision values. For example, a binormal precision-recall curve can be obtained by assuming decision values in both classes to follow a Gaussian distribution.
Average precision is also sometimes referred to geometrically as the area under the precision-recall curve.

R-Precision
Precision at R-th position in the ranking of results for a query that has R relevant documents. This measure is highly correlated to Average Precision. Also, Precision is equal to Recall at the R-th position.

Mean Average Precision
Mean average precision for a set of queries is the mean of the average precision scores for each query.

$$M A P = \frac{{\sum }_{q = 1}^{Q} AveP ( q )}{Q}$$

Where Q is the number of queries.

Discounted Cumulative Gain
DCG uses a graded relevance scale of documents from the result set to evaluate the usefulness, or gain, of a document based on its position in the result list. The premise of DCG is that highly relevant documents appearing lower in a search result list should be penalized as the graded relevance value is reduced logarithmically proportional to the position of the result.
The DCG accumulated at a particular rank position P is defined as:

$${DCG}_{p} = {rel}_{1} + {\sum }_{i = 2}^{p} \frac{{rel}_{i}}{{log}_{2} i} .$$

Since result set may vary in size among different queries or systems, to compare performances the normalised version of DCG uses an ideal DCG. To this end, it sorts documents of a result list by relevance, producing an ideal DCG at position p(IDCGₚ) which normalizes the score:

$${nDCG}_{p} = \frac{{DCG}_{p}}{IDCGp} .$$

The nDCG values for all queries can be averaged to obtain a measure of the average performance of a ranking algorithm. Note that in a perfect ranking algorithm, the DCGₚ will be the same as the IDCGₚ producing an nDCG of 1.0. All nDCG calculations are then relative values on the interval 0.0 to 1.0 and so are cross-query comparable.

Open domain question answering allows systems to take the users question and instead of using key words from the question, to use the whole interrogative and understand the context.

Knowledge Representation (KR) is a growing field in artificial intelligence; with various methods include heuristic question-answering, neural networks, theorem proving, expert systems and recently semantic networks including the Semantic Web, to build a web of structured documents.

Automated reasoning, a field focused on algorithms for automatically reasoning, including fuzzy logic and Bayesian inference.

Machine learning covers algorithms that allow intelligent decisions to be made on the basis of empirical data. Algorithm types in machine learning are commonly classified as: decision tree learning, association rule learning, artificial neural networks, genetic programming, inductive logic programming, support vector machines, clustering, Bayesian networks, reinforcement learning, representation learning, and sparse dictionary learning.

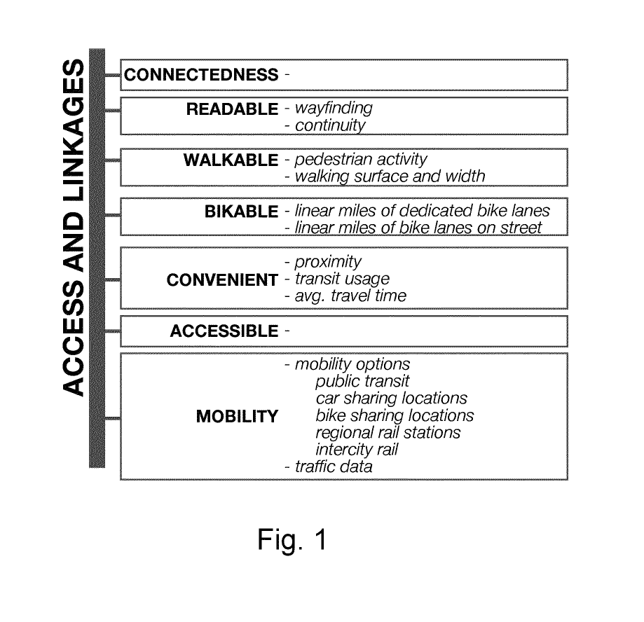

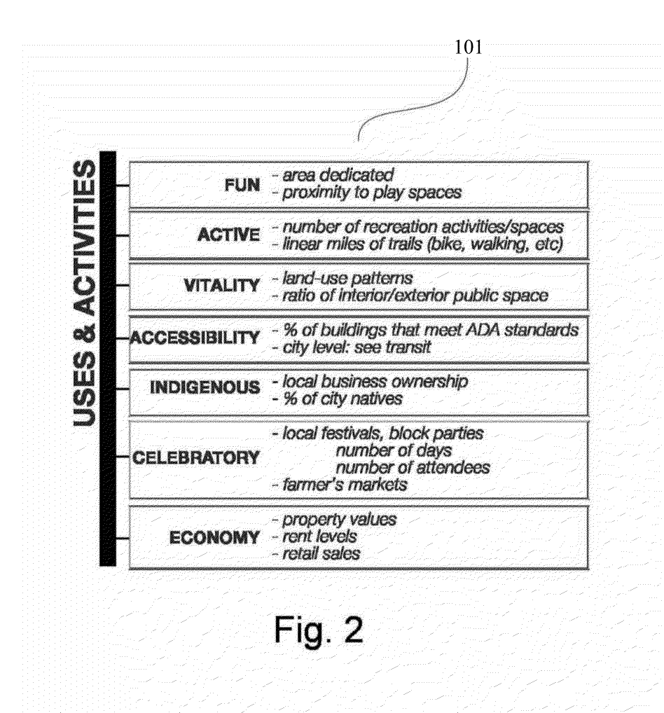

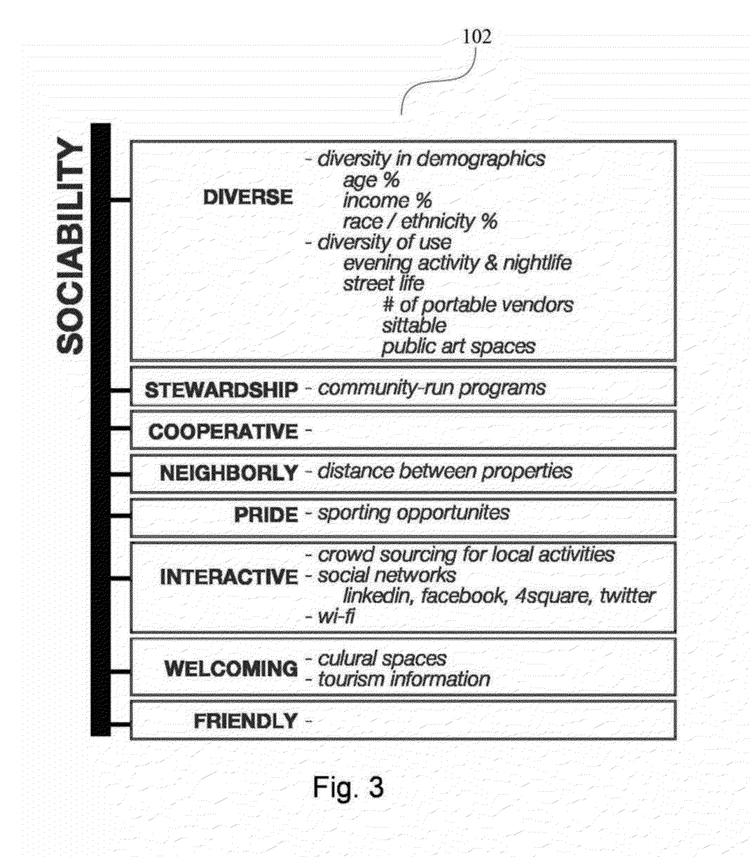

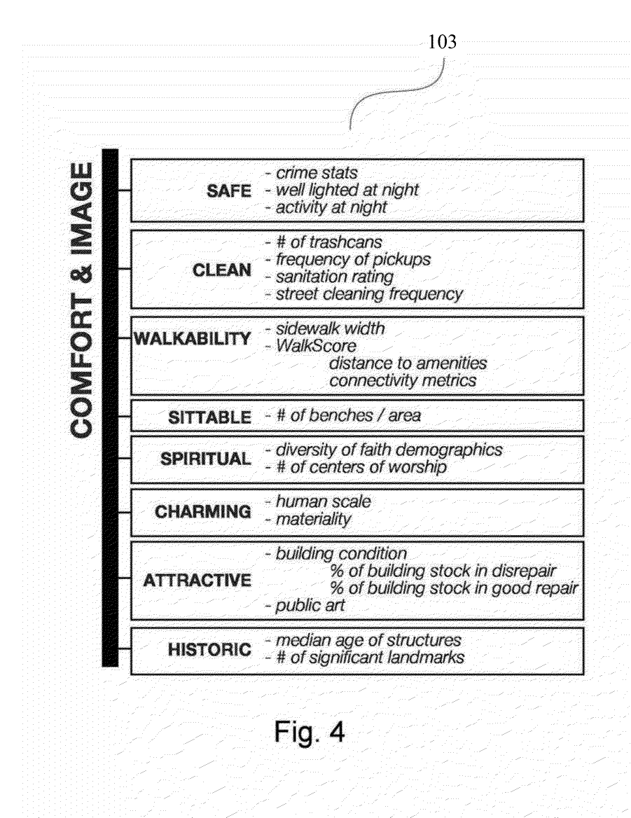

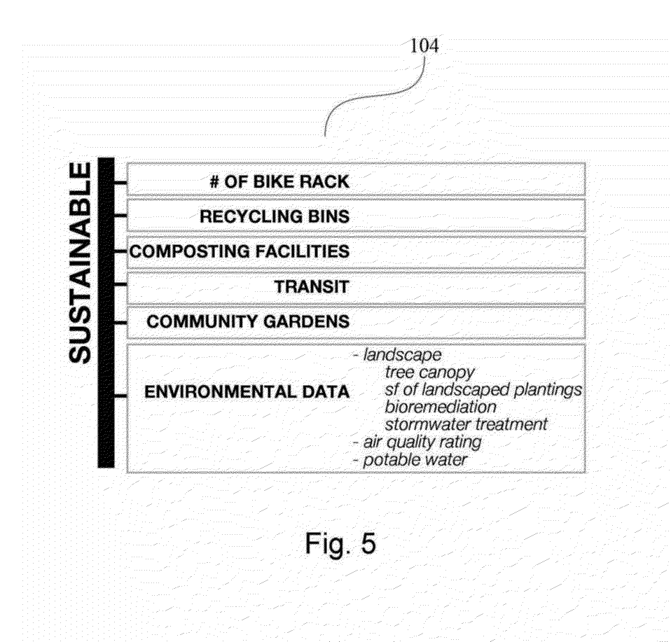

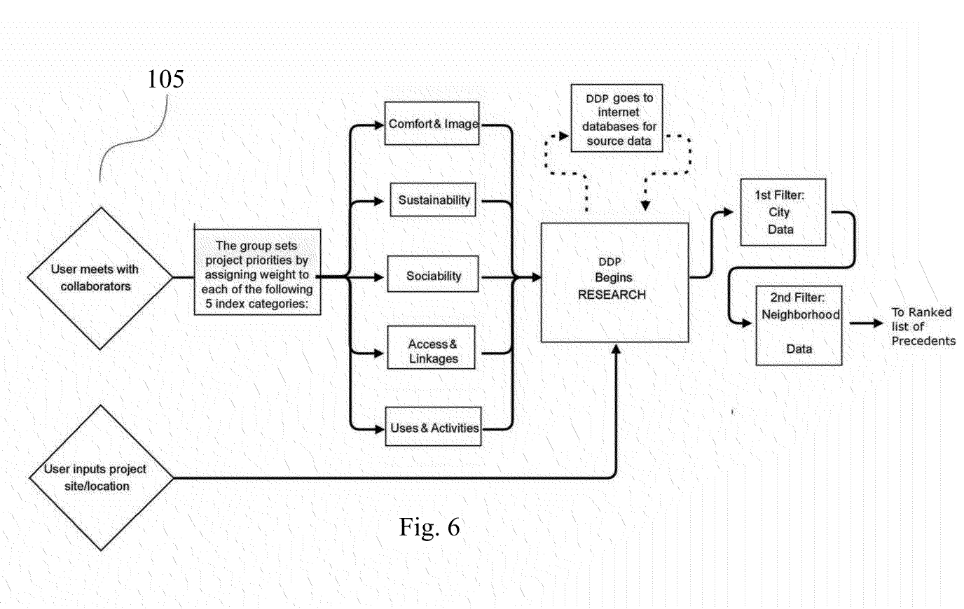

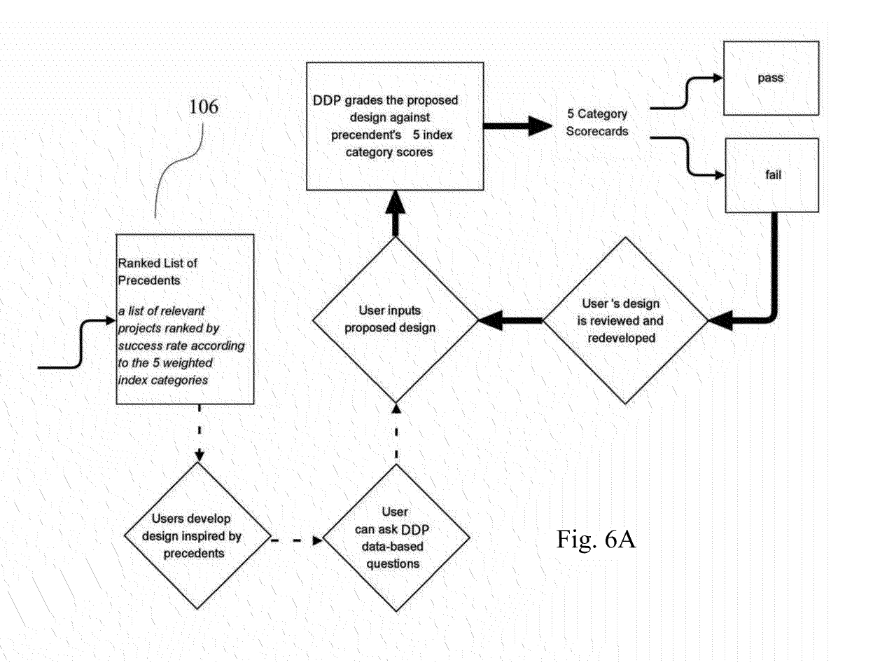

Referring initially to FIG. 6, the DDP system illustratively includes a model data storage device and processor, in the preferred embodiment the device is a natural language computer such as IBM's Watson, an artificial intelligence computer system. In accord with FIG. 6, DDP collects data points in index categories as illustrated in FIGS. 1 to 5.

These index categories serve as the criteria for a design's success. Advantageously, the index categories also serve as a rubric for project collaborators to lay out project goals and ambitions: at the beginning of the process that utilizes DDP, designers and project collaborators assign weight to each index category in order to communicate to the system which categories matter the most in accordance with the project's goals.

At the outset, an urban designer meets with the project collaborators and the individuals will set project priorities by assigning weight to each of the categories.

Advantageously DDP works with any number of categories. Most preferably DDP uses 5 categories: Comfort & Image, Sustainability, Sociability, Access & Linkages, and Uses & Activities. Advantageously, DDP may use 1 to 10 categories, advantageously from 1 to 20 categories, advantageously from 1 to 100 categories, advantageously from 1 to 200 categories, advantageously from 1 to 1000 categories, and advantageously more than 1000 categories. A weighted grade is applied to each category, according to its significance as a goal for the project. The user inputs the project location into DDP, prompting the system to begin research. Initially, DDP will reference the available source data as it begins filtering process.

In the most preferred embodiment of the Data Driven Placemaking invention, the system in software and/or hardware is comprised of features including: i) Modular architecture: Each type of operation may be enabled by different plug-in components (eg, IBM DeepQA or other methods including, but not limited to Petri Nets, Bayesian Nets, Markov Chain modeling); and ii) Devolution-Capable architecture: System functionality can be pruned (for instance, served to the user in a “stripped-down” independent runtime) in a fashion that delivers functionality limited to specific data-types, datasets, and/or category or other index criteria (eg, A module limited to sustainability category data for East Asia coastal regions with >1 million population near gambling casinos).

The DDP system in the most preferred embodiment has several features as will be appreciated by one skilled in the art. Broadly, the DDP invention affords collection of any volume of data, in any machine-readable or human-readable form, arising from individuals and institutions as well as automated sources including sensors, and which may be stored in any number of groups of silos. Additionally, such data (including papers, surveys, sentiment from community members, etc.) may be modified and addended with metadata, (which, affords, for instance, the capability to apply access, validation, and/or application restrictions to data elements). Such data and groupings of data may further be aggregated, divided, connected, manipulated, or transformed, and displayed in a predetermined fashion or at a given user's discretion.

Generally, the DDP System Architecture and Workflow as realized in hardware or software is envisioned to incorporate any or all of the following elements:

i) Data Input/Collection

ii) Data Methods/Schemas

iii) Data Validation/Curation/Vetting

iv) Data Storage

v) Data Data Selection/Transformation/Operations:

vi) Data Output

The System Architecture and Workflow affords and enables (in detail):

i) Data Input/Collection, of any data-type, including:

1. Zoning and code information (whether pre-existing or proposed)

2. Regulatory data: including measures relating to traffic flow, storm-water management, waterfront requirements/regulations, etc.

3. Best practices and recommendations: including guidelines for street and sidewalk widths, bike path properties, street furniture details, etc.

4. Ecologic data: including biologic, climate-related, geospatial, and other local-contextual data

5. Crowd-sourced or publicly-sourced data: including location-relevant ratings, questions, or aggregated and individual sentiments.

6. Sensor data: including time-varying and conditional data captured from city based sources (eg, air quality, traffic, tide timing, etc.)

7. Other index category or sub-index relevant data.

ii) Data Methods/Schema, implemented via:

1. Automated vs aggregated vs end-user entry;

2. Structured (templates, taxonomies) or unstructured (data mining, queries) means:

3. Additionally:

a. User-driven entry and/or validation can be by skilled professional, or general public; either for express purpose of populating data sets, or as an incidental product (by analogy, see the “CAPTCHA” combined-utility model of participatory human-identification and screened data verification)

b. Metadata may be applied to each data element or groups of data elements

c. Data or Metadata entry may be via native electronic transfer, or import from physical documents

iii) Data and metadata Validation/Curation/Vetting, conducted by any of:

1. In an automated fashion or from manual inspection by human users

2. By individual users or by groups of users

3. Via a static heuristic or algorithm, or via a continuous modeling (“learning”) process.

iv) Data Storage, implemented via:

1. Local systems, Software-as-a-service (SaaS), or other “cloud-based” services

2. Local storage on desktops, mobile devices, or data servers;

3. Relational databases, noSQL datastores, or other data models.

v) Data Data Selection/Transformation/Operations, which encompass:

1. A modular approach to creation of rules, and application of operations, and filtering (eg, Watson or other modeling and analysis tools).

2. Operations of Types including:

a. Comparator Identification: answering, for instance, the question “Given a range of values entered on a scorecard, what existing plans in the database are the best representatives of that set of scores?”

b. Baseline Scoring: answering, “How does a given plan score on a variety of endpoints, given a selected set of baseline data?”

c. Comparisons: answering, “How do two or more plans score on a relative basis, for selected classes/metrics?”

d. Forward optimization: answering, “Given a particular desired set of class objectives, how can the current design be changed to more closed meet the desired criteria?”

e. Reverse modeling: answering, “What common class characteristics best characterize a given comparator dataset?”

vi) Data Output, of which methods and content include:

1. Local precedent information (eg, data relating to other sites or plans with similarities to a given site or plan being designed and evaluated by the user).

2. Design feedback in form of scorecards relating to index categories or other metrics, evaluating whether or not project meets local design/zoning code limitations.

3. Other design feedback in form of scorecards evaluating how design does against major indices related to good urban planning.

4. Qualitative aspects of city planning, including unstructured comments and sentiment.

5. A graphical and or tactile information representation or manipulation system as part of the Data Input and Data Output feature-sets. This includes, an electronic, graphical display of data (in time-point, or time-series (aka “evolutionary”) modes); enabled by:

a. Rules, AI engines, and data models

b. Graphical and/or numerical/textual scores, visualizations, and summaries

c. Additional user-defined or predefined “meta-endpoints” and “meta-scores” for use in engineering cities for health/psychological endpoints, or various measures relevant for the design of enterprise zones and innovation districts.

Furthermore, in the preferred embodiments of the invention, index categories for the model are divided into sub-categories as shown in FIG. 1 to FIG. 5. Sub-categories include but are not limited to:

i) Connectedness; including model variables for adjacencies of related spaces, neighborhoods, or communities

ii) Readable, including model variables for way finding and continuity;

iii) Walkable, including model variables for pedestrian activity, walking surfaces including sidewalk and street width, walking distances, elevations, obstructions, impediments, and other aspects that impact the experience of walking in a city;

iv) Bikable, including model variables for linear miles of dedicated bike lanes, linear miles of bike lanes on street, bicycle safety and support systems, infrastructure, biking distances, elevations, obstructions, impediments, and other aspects that impact the experience of bicycling in a city;

v) Convenience, including model variables for proximity, transit usage, average travel time;

vi) Mobility, including model variables for mobility options, public transport, car sharing locations, bike sharing locations, regional rail stations, intercity rail, traffic data;

vii) Fun, including model variables for area dedicated and proximity of play spaces (for adults and children);

viii) Active, including model variables for number of recreation activities/spaces, linear miles of trails (bike, walking, etc.);

ix) Vitality, including model variables for land use patterns, ratio of interior/exterior public space;

x) Accessibility, including model variables for percent of buildings that meet ADA standards, city wide accessibility including ease of getting around, equal access to all areas of city;

xi) Indigenous, including model variables for local business ownership, percent of city natives;

xii) Celebratory, including model variables for local festivals, block parties, number of days of festivals, number of attendees at festivals, farmer's markets;

xiii) Economy, including model variables for property values, rent levels, retail sales;

xiv) Diversity, including model variables for diversity in demographics, age percentage, income percentage, race/ethnicity percentage, diversity of use, evening activity and nightlife, street life, number of portable vendors, sittable, public art spaces;

xv) Stewardship, including model variables for community-run programs;

xvi) Cooperative, ability of community to connect to one another as well as to outside communities and agencies;

xvii) Neighborly, including model variables for distance between properties;

xviii) Pride, including model variables for sporting opportunities and other aspects that initiate pride of place;

xix) Interactive, including model variables for both networked and social gatherings, networked aspects can include crowd sourcing for local activities, social networks, LinkedIn, Facebook, 4square, Twitter, Wi-Fi;

xx) Welcoming, including model variables for cultural spaces, tourism information;

xxi) Friendly; including model variables of how warm and friendly a community can be, do people say hello to one another, how do people treat each other while driving and in public spaces,

xxii) Safe, including model variables for crime statistics, well lighted at night, activity at night;

xxii) Clean, including model variables for number of trashcans, frequency of pickups, sanitation rating, and street cleaning frequency;

xxiii) Walkability, including model variables for sidewalk width, WalkScore (or other similar methods for modeling walking distances), distance to amenities, connectivity metrics;

xxiv) Sittable, including model variables for number of benches/area;

xxv) Spiritual, including model variables for diversity of demographics, number of centers of worship

xxvi) Charming, including model variables for human scale, materiality;

xxvii) Attractive, including model variables for building conditions, percent of building stock in disrepair, % of building stock in good repair, public art;

xxviii) Historic, including model variables for median age of structures, number of significant landmarks;

xxix) Sustainability, including model variables for number of “green” buildings (by using LEED or similar metrics), or green neighborhood certifications

xxx) Health, including model variables related to the improvement of the health of the community such as, opportunities to exercise, local food sources, community gardens, education programs about individual carbon footprints, and understanding of individual health metrics including heart rate, caloric intake, air quality rating,

xxxi) Alternative transportation, including model variables for number of Bicycle Racks and bike paths, car share programs, public transportation systems, and other modes of transportation that reduce vehicular traffic and congestion,

xxxii) Waste, including model variables related to the reduction of waste, recycling Bins, Composting Facilities;

xxxiii) Environmental Data, including model variables for landscape, tree canopy, square feet of landscaped plantings, bioremediation, storm water treatment, potable water;

xxxiv) Water, including model variables for residential, hotel, cultural, office water usage, resource management strategies, grey and black water systems, stormwater management strategies,

xxxv) Energy, including model variables for residential, hotel, cultural, office energy usage, energy generation including district scale energy distribution, alternative energy strategies;

Subsequently, the first of two filters consider the project's city data (regional scale conditions), using the conditions to eliminate possible precedent cities that differ from the land, climate, scale, etc. of the project city. A model design that is successful in downtown Hong Kong is not likely to succeed in Springfield, Mass. nor has comparable existing conditions and thus, will be filtered out.

Furthermore, a second filter identifies the neighborhood scale model variables from the project's site such as population, demographics, transportation, local economy, etc. Using the neighborhood data for model variables, DDP finds relevant precedents where designers dealt with similar starting conditions.

It is a particular feature of the present invention where DDP furthermore filters through the inputted city and neighborhood data, the system narrows down a list of examples of similar urban neighborhoods that are considered successful, ranked by success rate according to the weighted index categories.

It is another feature of the invention that upon receiving the ranked list, the user transitions the design process from analysis to design concept and development. During the design phase, the user can access design model variables of DDP with specific queries concerning the site, as seen in FIG. 6 and FIG. 6A.

It is another feature of the invention that community members can voice their opinions and suggestions through social media. DDP users take the community's advice into model variables and incorporate it into the model design.

Furthermore as shown in FIG. 6A, the design is inputted into DDP, subsequently DDP operates to grade the proposed design against the precedent's index categories and sub-categories. Advantageously in the preferred embodiment of the invention, the proposed model design receives a scorecard that tells the user whether the model design is successful or non-successful for each sub-category, in other words the design passed or failed on each sub-category. It is another feature of the present invention that if the design receives a failed assessment on an individual category or sub-category, the user may redesign the flawed elements until DDP gives a passing grade. Once a passing grade is assigned, the design is considered a success.

Advantageously, the model variables may be depicted as a score from 1 to 5 stars, or on a scale from 1 to 10, by letter grades, percentages, points, ideograms, pictographs or another grading scale as appropriate.

### EXAMPLES

### Example 1

### Walkability

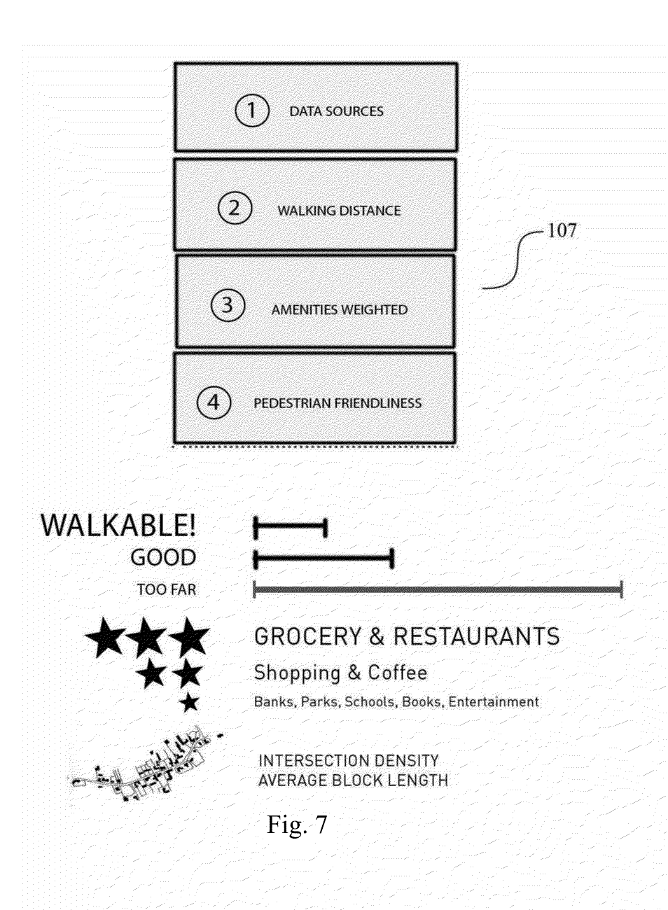

Walkability is a category that considers one's commute; model variables include amenities in walking distance and the quality for the experience of the pedestrian. Advantageously DDP analyzes the walkability of both proposed design model neighborhoods and built. The process of determining walkability as in FIG. 7 first uses located data sources for model variables that is referenced when computing the score and ratings, such as Google, Localeze, Open Street Map, education.com and schedules from transit agencies. Furthermore, information on grocery, restaurants, shopping, coffee, banks, parks, schools, books, entertainment, intersection density and average block length may be used as model design variables.

Furthermore, model variable data may include spatial and cultural data used to analyze proposed plans include GIS data from states, cities and nations. As well as census, cultural and economic data, LiDAR and Landsat imaging, as well as agencies such as the USGS, NASA, NOAA and USDA.

### Example 2

### Non-Successful DDP Design Precedent Hartford, Conn.

It is another feature of the invention for DDP to compare designs that are successful in comparable existing conditions as well as designs that are non-successful.

City: Hartford, Conn.

Neighborhood: Downtown Hartford

City Data:

Ranking: Undefined

Land Area: 17.3 square miles

Population: 124,060 in 2000

Economy: Medium income $28,300;

⅓ of population poverty stricken

Universities: Over 6,000 students

Key problems/struggle: Crime/poverty

Connections: Major airport for international flights; highways

Climate: Coastal+Northern

Overview: Hartford was considered one of the greatest cities in the United States up until the introduction of the automobile. When interstates 84 and 91 were created, both bordering downtown Hartford, the city floundered.

### Evidence of Non-Success in the Neighborhood:

Low percentage of population taking public transportation
High crime rate
High poverty rate
Low green space land percentage
Low diversity in building uses resulting in low occupancy rate during night
High percentage of city's edge touching highway

### Example 3

### Non-Successful DDP Design Precedent Cambridge, Mass.

It is another feature of the invention for DDP to compare designs that are successful in comparable existing conditions as well as designs that are non-successful.

City: Cambridge, Mass.

Neighborhood: Kendall Square

Ranking: Undefined

Land Area: 1.241 square miles

Population: 12,940

Economy: MIT owns a lot of commercial real estate; business in neighborhood is technology driven

Universities: MIT nearby

Connections: Bus Routes and MBTA Red Line

Climate: Coastal+Northern

Overview: In the 1990s and 2000s, the area between Kendall and Cambridge Side Galleria transformed into what it is today. The square currently holds many offices, research buildings, biotechnology firms, and information technology firms. As a result, the square is only occupied during office hours.

### Evidence of Non-Success in the Neighborhood:

Low green space and land percentage.
Low diversity in building uses resulting in low occupancy rate during night.
Building height results in wind tunnel effect.
Low number of retail and restaurant space.

### Example 4

### Successful DDP Design Precedent Malmo, Sweden

It is another feature of the invention for DDP to compare designs that are successful in comparable existing conditions as well as designs that are non-successful.

City: Malmo Sweden

Neighborhood: Västra Hamnen, City of Tomorrow

Ranking: Undefined

Land Area: 155.56 km2 (60.1 sq mi)

Population: 280,415, 30% of foreign origin

Economy: 9th lowest median income in

Sweden, 2004, the rate of wage-earners was 63%

Universities: Malmö University College—23,900

City historic type: Industrial (Port)

Connections: The Øresund Bridge connects Malmo to Copenhagen, Denmark (a Beta+ranked city)

Climate: Oceanic climate—mild, Northern

Overview:

This was a waterfront—former port/shipbuilding center, industry had declined since the 1960s and left most of the area vacant and in disrepair. A large team of Swedish architects and planners worked on a redevelopment of the area, more is planned in adjacent similarly conditioned areas. There are now over 1,300 homes which all use very little energy, as they are highly insulated, and linked to a district heating scheme, with 1,000 (or 85%) homes off a heat pump to the underground aquifer. A single wind turbine supplies all the electricity and the standard is to consume under 70 kwh per sq. meter. Waste is put in a “recycling house” and food waste is turned into bio gas which is used to run the buses. There are only 0.7 parking spaces per home and these are largely provided underground or in a multi-story ‘parking house’ and there is a car pool. Bikes are used extensively and buses come every seven minutes and reach the central station and shopping area in less than ten.

### Evidence of Success in the Neighborhood:

Everyday 15,000 people visit the area's newly landscaped waterfront.
Residents generally praise their neighborhood.

### Example 5

### Successful DDP Design Precedent Portland, Oreg.

It is another feature of the invention for DDP to compare designs that are successful in comparable existing conditions as well as designs that are non-successful.

City: Portland, Oreg.

Neighborhood: the Pearl District

Ranking: Undefined

Land Area: 1.21 km2

Population: 1,113 (Pearl District)

Economy: The work force is well-educated and very stable. The job turnover rate is low and productivity is high.

Universities: University of Portland, Portland State University, Concordia University

Connections: Portland International Airport, 2 interstate highways, Amtrak, TriMet transit system, MAX light rail, bus service.

Climate: Mild temperatures, coastal NW

Overview:

The Pearl District was formerly occupied by warehouses, light industry and railroad classification yards and now noted for its art galleries, upscale businesses and residences. The area has been undergoing significant urban renewal since the late 1990s

### Evidence of Success in the Neighborhood:

Revitalized from dilapidated warehouse and rail yard into diverse, urban district in 20 year period.
Demolition of the Lovejoy Ramp, construction of the Portland Streetcar, two urban parks.
Hoyt Yards is currently a part of a pilot program for LEED certification of entire neighborhoods called LEED for Neighborhood Development.
Captured rainwater system used for landscape irrigation.
24% less energy use and 30% less water usage.
Convenient, alternative transit options reducing car commutes.

### Example 6

### DDP Testing the Design Model for ResilienCityDDP

It is another feature of the invention for DDP to compare proposed design model with designs that are successful in comparable existing conditions as well as designs that are non-successful.

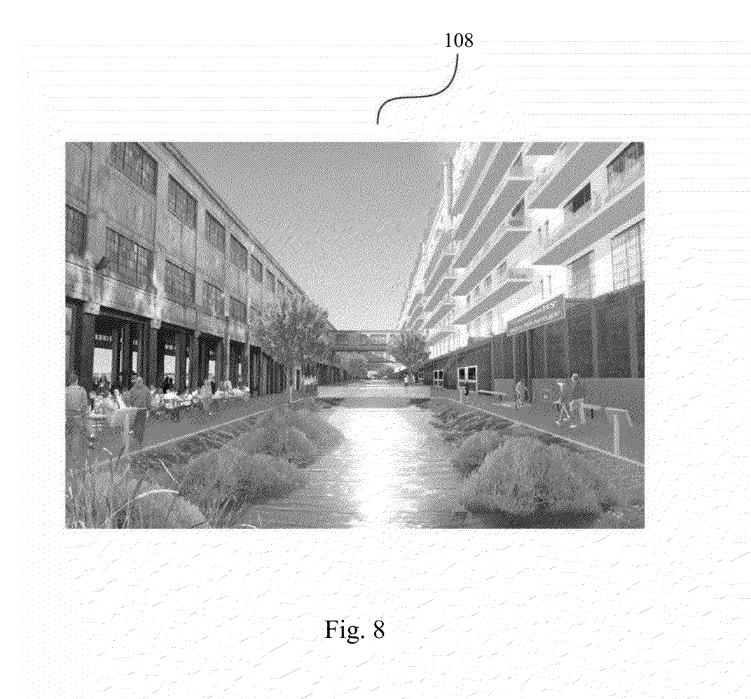

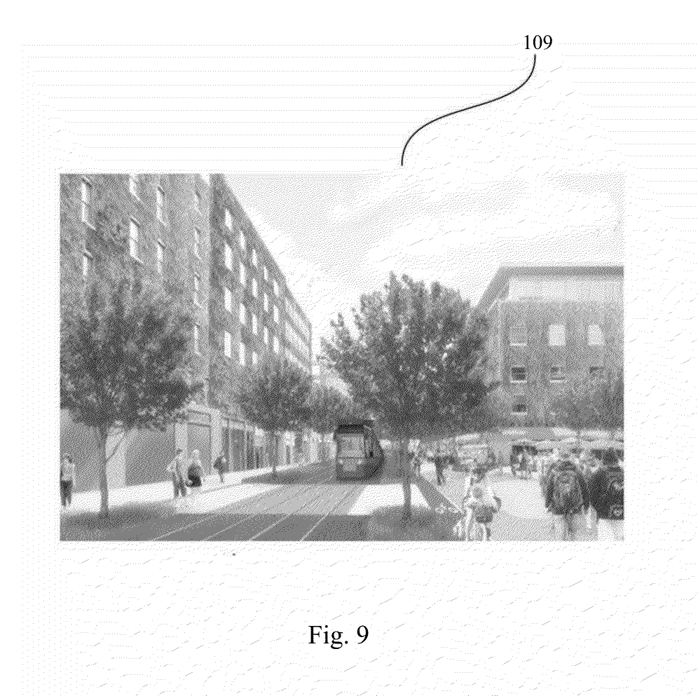

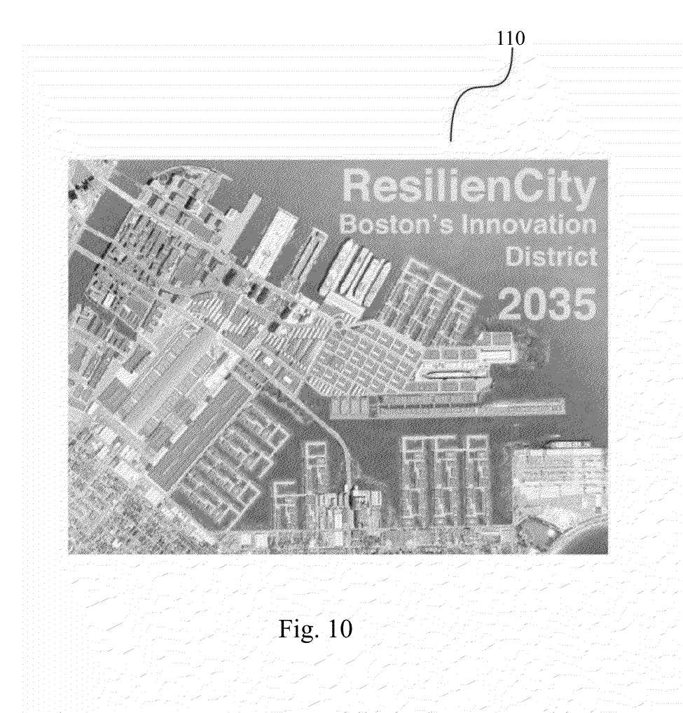

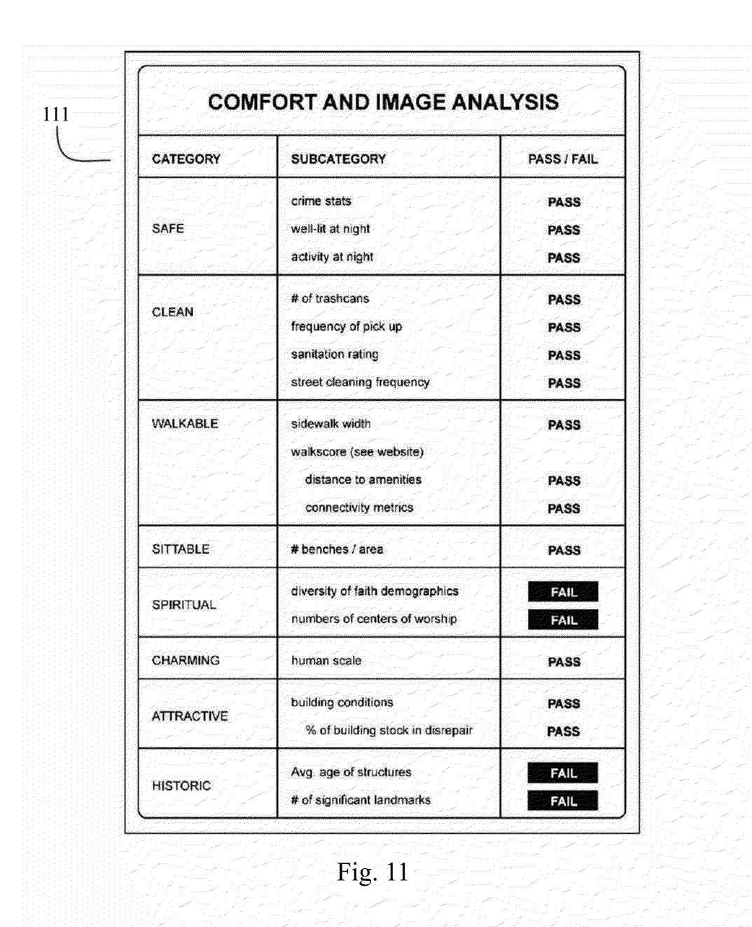

FIGS. 8 through 10 show ResilienCity, a design for the burgeoning Innovation District in Boston. New residences and workplaces are provided, in addition to repositioned green spaces. ResilienCity creates an environment that is culturally enriching, healthy, and equitable by focusing on site, water, energy, health, materials, equity, and beauty. DDP tests ResilienCity by inputting the design into the system and generates a five-category scorecard FIG. 11-15. ResilienCity design proposal is available in more detail at http://www.map-lab.com/lab_blog/2011/5/5/resiliencity-bostons-innovation-district-2035-1.html.

### FIG. 11 DDP Scorecard Explanation for Comfort and Image of ResilienCity:

As shown in FIG. 11, ResilienCity design model performs adequately in terms of comfort and image. DDP analysis of the model variables determines the proposed design model is safe, clean, walkable, and sittable according to the design scheme of ResilienCity's base elements. The design also passes in terms of charm and attractiveness due to ResilienCity's attention to human scale and implementation of natural qualities. While the scheme excels in these areas, ResilenCity lacks spiritual and historical elements. Since the design is a total renovation of Boston's Innovation District, there are no historical landmarks or structures present. In addition, the design proposal never mentions spiritual diversity or spiritual spaces, resulting in a fail for both.

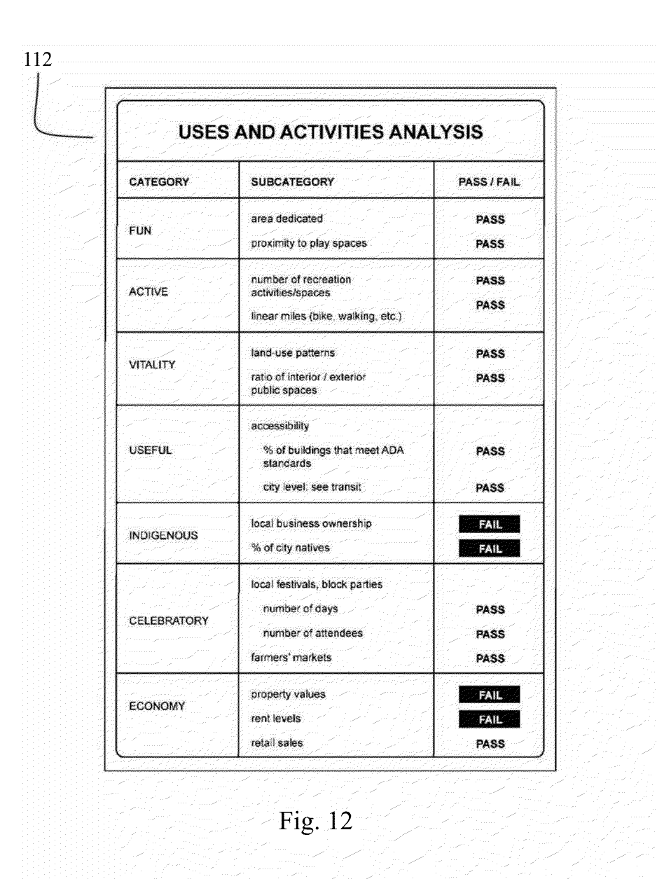

### FIG. 12 DDP Scorecard Explanation for Uses and Activities:

As shown in FIG. 12 In terms of uses and activities, ResilienCity performs satisfactorily. The city provides sufficient spaces for community enjoyment such as green spaces, farmers markets, retail spaces, and restaurants, as set forth in the design model proposal. In addition, every element of ResilienCity is deigned to be easily accessible and safe for all civilians. Where the design fails was in its lack of indigenous and economic qualities. As previously mentioned, ResilienCity is a renovation of Boston's Innovation District; therefore nothing indigenous exists in its design. Furthermore, all residential spaces are new which means higher rent expenses and property values, resulting in a fail for economy.

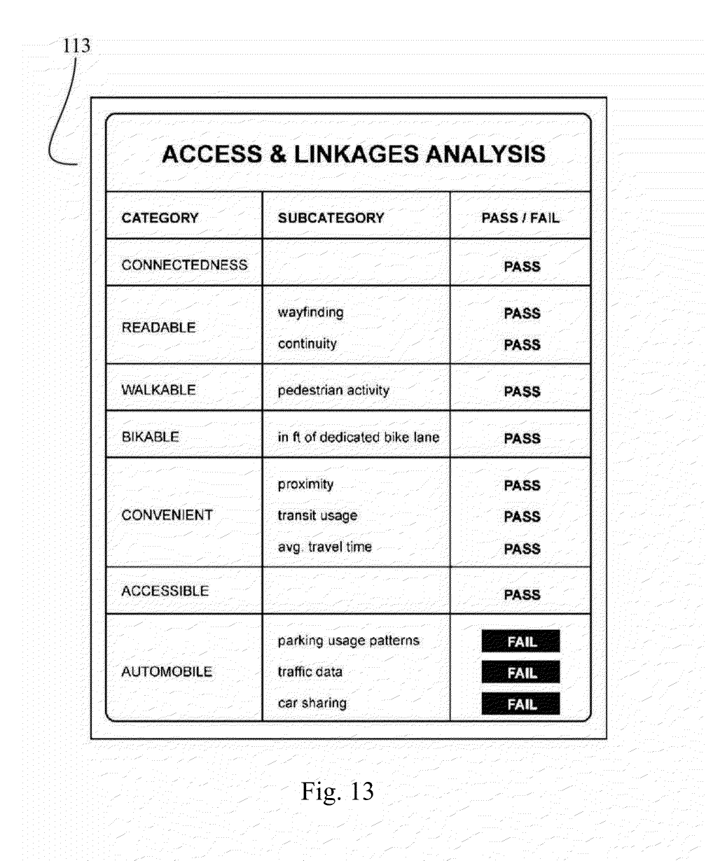

### FIG. 13 DDP Scorecard Explanation for Access and Linkages:

As shown in FIG. 13, the design encourages all visitors and residents to be more physically active by reducing vehicular traffic and increasing public transportation. In the design, the MBTA Green Line extends to Congress Street, thus linking ResilienCity to other parts of Boston. In addition, the design proposes an elevated bike rail and community bike shelter to improve upon transportation. While the design excels in terms of connectedness, readability, walkability, bikability, convenience, and accessibility, ResilienCity fails in terms of vehicular mobility. The design proposes a neighborhood that is a car-free zone, which in 2035 may be a welcomed feature however, today man still depends upon cars. As a result, ResilienCity receives three fails for the sub-category on automobile access and linkage.

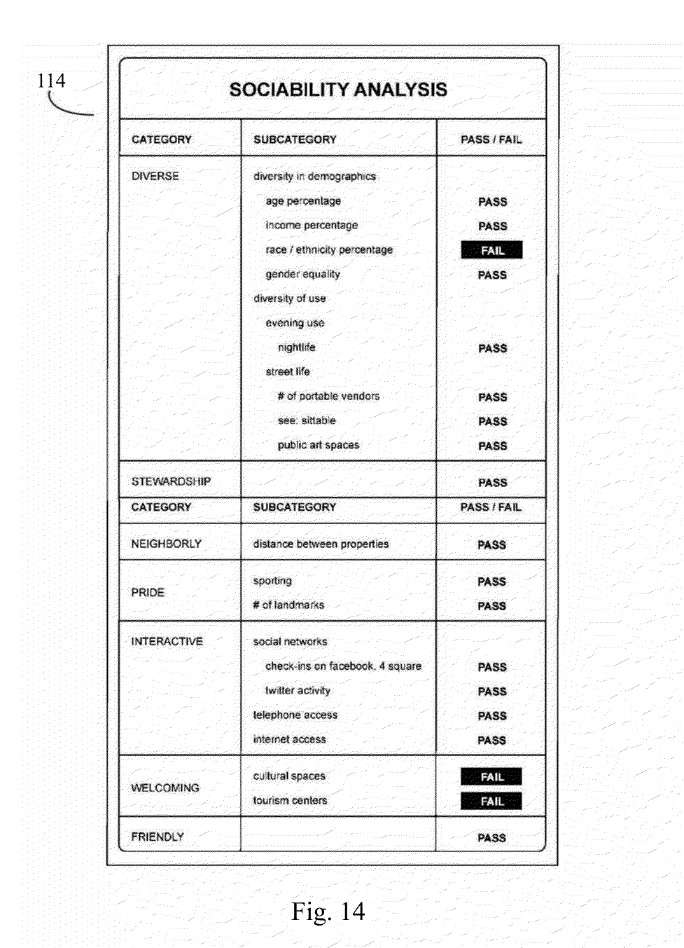

### FIG. 14. DDP Scorecard Explanation for Sociability:

As shown in FIG. 14, ResilienCity performs extremely well in the sociability category. The design receives perfect scores in all areas except for diversity. While it is evident that ResilienCity is diverse in terms of age, income, and gender, there is no mention of racial diversity in the design. As a result, the users need to assume that this is not a priority of the design.

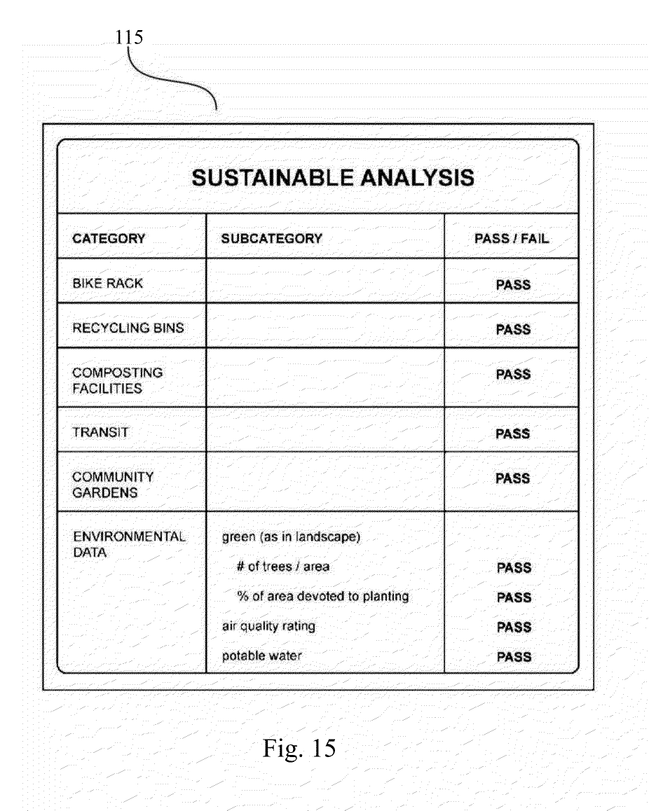

### FIG. 15 Scorecard Explanation for Sustainable Analysis:

As shown in FIG. 15 ResilienCity receives a perfect score for its sustainable design. Every element of the design attempts to incorporate a sustainable technique. In fact, the design is so sophisticated that ResilienCity produces more energy than it requires, thus supplying energy to adjacent communities.

The project leaders evaluate ResilenCity's project goals and using DDP scorecards to evaluate every measurable element, DDP shows the design is largely successful. Perhaps the greatest flaw in ResilenCity's design is its lack of indigenous factors. Most of ResilienCity's design consists of new buildings, resulting in higher rent expenses and property values. Nonetheless, the other five category indexes overpower this defect, thus resulting in a lucrative, dynamic design.

That which is claimed:

1. A modeling method for Data Driven Placemaking comprising: a data processing device configured to store model data based on one or more precedent locations; a system of one or more index categories, said index categories having at least one variable corresponding to the index category; said variable having a magnitude, said data processing device transforms the model data relevant to the index categories; and subsequently providing a score for each of the said index categories for a location.

2. The method of claim 1 wherein the said data processing device is computer system, whether hardware or software or a combination thereof, incorporating an analytic function enabled by any of the following: a scoring algorithm, an expert system, an inference engine, a modeling system, a simulation process, or artificial intelligence system.

3. The method of claim 1 wherein the said score is a pass or fail for each index category.

4. The method of claim 1 wherein said score is selected from the group consisting of 1 to 5 stars, on a scale from 1 to 10, by letter grades, percentages, points, ideograms, and pictographs

5. The method of claim 1 wherein the said model design may be reviewed and redeveloped and resubmitted to the said data processing device.

6. The method of claim 1 wherein the relationship for the index category and magnitude is selected from the group comprising of: Optimal, Good, or Baseline.

7. The method of claim 1 wherein the score of the index categories is based on magnitude.

8. The method of claim 1 wherein the index categories are selected from the group consisting of Comfort & Image, Sustainability, Sociability, Access & Linkages, and Uses & Activities.

9. The method of claim 1 wherein the index categories are selected from the group consisting of Connectedness, Readable, Walkable, Bikable, Convenience, Mobility, Fun, Active, Vitality, Accessibility, Indigenous, Celebratory, Economy, Diversity, Stewardship, Cooperative, Neighborly, Pride, Interactive, Welcoming, Friendly, Safe, Clean, Walkability, Sittable, Spiritual, Charming, Attractive, Historic, Sustainability, Health, Alternative transportation, Waste, Environmental Data, Water, and Energy.

10. The method of claim 1 wherein the model data is filtered for a regional scale condition of a location to eliminate one or more precedent locations.

11. The method of claim 1 wherein the model data is filtered for one or more neighborhood scale conditions of a location to include one or more similar precedent locations.

12. The method of claim 1 further comprising the steps of
a. inputting into said data processing device site specific zoning and code information, regulatory data related to specific site conditions, traffic, stormwater management, waterfront requirements/regulations, best practices and recommendations for good urban spaces including street, sidewalk widths, bike paths, street furniture, climate, geo-data, local-context relevant data, crowdsourced data, location-relevant subjective sentiments, sensor data, captured from city based sources, air quality, traffic, tides, research papers, surveys, community chat boards;
b. the said transformation further selecting from the group consisting of Comparator Identification, Baseline Scoring, Comparisons, Forward optimization, Reverse modeling;
c. said score, further comprising local precedent information with similar conditions, design feedback in form of scorecards evaluating whether or not project meets local design/zoning code limitations, design feedback in form of scorecards evaluating how design does against major indices related to good urban planning.

13. A Data Driven Placemaking device, comprising:
a. a computing device configured to establish relationships between a plurality of location specific data,
b. receiving location-specific data from a user and determining whether the location specific data has a defined relationship with an index category,
c. providing a communication based on a determination that the location specific data has a defined relationship with an index category,
d. providing the ability to select the relationship of the location specific data with an index category,
e. wherein the computing device generates a score for the index category.

14. The Data Driven Placemaking device of claim 13 wherein the score for the index category is a pass or fail for each category.

15. The Data Driven Placemaking device of claim 13 wherein the relationship for the location specific data and index category is selected from the group comprising of: Optimal, Good, or Baseline.

16. The Data Driven Placemaking device of claim 13 wherein the said data processing device is an artificial intelligence computer system.

17. The Data Driven Placemaking device of claim 13 wherein the index categories are selected from the group consisting of Comfort & Image, Sustainability, Sociability, Access & Linkages, and Uses & Activities.

18. The Data Driven Placemaking device of claim 13 wherein the index categories are selected from the group consisting of Connectedness, Readable, Walkable, Bikable, Convenience, Mobility, Fun, Active, Vitality, Accessibility, Indigenous, Celebratory, Economy, Diversity, Stewardship, Cooperative, Neighborly, Pride, Interactive, Welcoming, Friendly, Safe, Clean, Walkability, Sittable, Spiritual, Charming, Attractive, Historic, Sustainability, Health, Alternative transportation, Waste, Environmental Data, Water, and Energy.

19. The Data Driven Placemaking device of claim 13 wherein the model data is filtered for a regional scale condition of a location to eliminate one or more precedent locations.

20. A computer-implemented Data Driven Placemaking system, comprising:
a category magnitude generator for a location that produces data indicative of one or more location categories;
a transformation generator that analyzes the category magnitude of each of one or more index categories;
means for generating one or more scores for each of the index categories.

21. A computer-implemented Data Driven Placemaking system described in claim 20, comprising:
means for displaying or manipulating in a graphical format or via a tactile device any of elemental data, groupings of data, or other data indicative of one or more location categories;
means for graphical display of any of elemental data, groupings of data, or other data indicative of one or more location categories.
